(19) United States
(12) Patent Application Publication
(10) Pub. No.: US 2016/0074682 A1
(43) Pub. Date: Mar. 17, 2016

(54) Butterfly Type Exhalation Valve

(71) Applicant: Mahesh KUDAV, Navi Mumbai, Maharashtra (IN)

(72) Inventor: Mahesh KUDAV, Navi Mumbai, Maharashtra (IN)

(21) Appl. No.: 14/787,670

(22) PCT Filed: Apr. 28, 2014
(86) PCT No.: PCT/IN2014/000281

§ 371 Date: Oct. 28, 2015

(30) Foreign Application Priority Data
Apr. 28, 2013 (IN) 1197/MUM/2013

(51) Int. Cl. A62B 18/10; F16K 1/22

(52) U.S. Cl. CPC A62B 18/10; F16K 1/22

(57) ABSTRACT

A butterfly type exhalation valve comprises a bottom valve body of cylindrical/oval shape with a boss at one end provided with smooth surface at other end to form a valve seat for mounting a butterfly type diaphragm. A support provided at center of internal diameter with two or more sector openings forming exhalation slots. A solid pin forming a fulcrum for the diaphragm provided in the center of the support. One or more locking grooves provided to the outer vertical surface of bottom valve body. A cap having a rigid top is provided with a hollow pin, at center, in the inner side to engage the solid pin of the valve body when mounted over the bottom valve body after locating the diaphragm to the solid pin. One more slots on the side surface just below the top of the cap provide for passage to exhalation air.

### FIELD OF THE INVENTION

The present invention relates to butterfly type exhalation valve. More particularly present invention relates to butterfly type exhalation valve that has a butterfly wing shaped cut feature on the valve that allows the performance of the valve to exceed and improve.

### BACKGROUND OF THE INVENTION

The main function of exhalation valve is to blow exhaled air out during respiration cycle. During this process the valve opens out due to exhalation pressure. Such types of valves having this function are known as Non return valve (NRV). There are various types of respirators, face pieces & hoods such as fold flat respirators, cup shaped respirators, elastomeric face-pieces half/full-face masks or hood to cover head. These respirators have elastic fitment, adjuster beads, nose strip or nose clip so that the respirator fits on the nose. The respirators which do not have valves fitted on them show disadvantages. They have increased resistance to air venting thus affecting comfort, warm air remains inside the respirator increasing suffocation during exhalation process causing discomfort.

The exhalation valve according to the present invention proposes to make on respirators comprises of a butterfly wings shape diaphragm valve.

### PRIOR ART

Unidirectional valves are well known in the art. Exhalation valves have been used in filtering face masks for many years as disclosed in U.S. Pat. Nos. 4,981,134, 4,974,586, 4,414,973. A common type of exhalation valve comprises an oval diaphragm of elastomeric material and a polymer article co-operating oval valve seat surrounding the orifice which passes the user's exhalation. The diaphragm is clamped at its centre or top and marginal portions flex away from the seat when the user exhales. In another known type the diaphragm is in the form of a flexible flap which is attached to a cooperating seat structure at one end, that is to say in cantilever fashion, and flexes away from the rest of the seat when the user exhales. In the design of an exhalation valve it is important to maximize the cross-sectional area of the open orifice to allow free flow of exhalation through the valve, and also to minimize the differential air pressure required to open the valve (i.e. the valve “cracking” pressure).

As per U.S. Pat. No. 4,934,362 and U.S. Pat. No. 5,325,892 centrally clamped diaphragm valves require a greater force to open them than cantilevered flap type valves of equivalent size because their available “lever arm” is less. Furthermore, the structure of a cantilevered flap type valve, when open, generally presents less of an obstruction to flow than the centrally clamped circular diaphragm type valve, or in other words imposes a smaller pressure drop for a given orifice size. A potential problem which must be addressed in the design of a cantilevered flap valve, however, lies in ensuring that the flap will remain closed in all orientations of the structure while it is not subject to an exhalatory pressure differential. That is to say, while in order to minimize the opening pressure differential of the valve it is desirable to employ a highly flexible flap of minimal thickness, the very flexibility of the flap may mean that if the valve is inverted in use (i.e. orientated with the seat lying above the flap), the flap may drop down from the seat when the user is not exhaling or inhaling at very low flow rates. This is clearly undesirable as it may open a leakage path into the mask for the contaminants which it is intended to exclude.

### OBJECT OF THE INVENTION

Object of the present invention aims at developing a butterfly type exhalation valve. It is also an object of the present invention to provide non return exhalation valve that has a butterfly wing shaped cut feature on the valve that allows the performance of the valve to exceed and improve as per various prior arts.

It is also an object of the present invention to eliminate the limitation and short comings of prior art.

### STATEMENT OF INVENTION

Accordingly invention provides a butterfly type exhalation valve comprises a bottom valve body of geometric shape with a boss at one end provided with smooth surface at other end to form a valve seat for mounting a butterfly type diaphragm; a support means provided at centre of internal diameter with two or more sector openings forming exhalation slots; one or more solid pins forming fulcrum for said diaphragm provided in the centre/centre at distant on the said support; one or more locking grooves to the vertical surface of said bottom valve body; a cap/lid means having rigid top provided with one more hollow pin, at centre/centre at distant, in the inner side to enable to engage to said solid pin/pins of said valve body with locking when mounted over the bottom valve body after locating said diaphragm to the said solid pin/pins; one more slot on the side surface just below the said top of said cap/lid provided for passage to exhalation air.

### SUMMARY OF THE INVENTION

According to the present invention a butterfly wing shaped diaphragm that is present within a top cap/lid or lid and bottom seat to hold the valve in a particular position with respect to its working that allows the valve to work in a better manner as per its performance and features. Pin in valve bottom/base is of precise diameter; do not create any distortion or surface tension on diaphragm.

### BRIEF DESCRIPTION OF FIGURES

Invention described with reference to the figures of the accompanying drawings wherein:

FIGS. 1a, 1b, 1c, 1d & 1e illustrate Exhalation valve bottom seat from upper side;

FIG. 2 shows the isometric view of exhalation valve bottom elostomeric diaphragm vale removed; FIG. 2a shows front view exhalation valve with elastomeric valve mounted therein; FIG. 2b shows side view the bottom valve body; FIG. 2c shows bottom view of valve bottom;

FIG. 3 shows the isometric view of the upper lid from top side

FIG. 3a illustrates the front view of the upper lid

FIG. 3b illustrates the side view

FIG. 3c illustrates the back view

FIG. 4 illustrates another isometric view of the upper lid from bottom side

FIGS. 5a to 5e illustrates the working of diaphragm during inhalation process

FIGS. 6a to 6e illustrates the working of diaphragm during exhalation process

FIGS. 7a to 7e illustrates the elastomeric diaphragm as the critical part of exhalation valve along with the polymer top and seat assembly.

FIG. 8a shows butterfly valve diaphragm bottom of unsymmetrical shape provided with two number of fulcrum pin; FIG. 8b shows top view FIG. 8a.

### BRIEF DESCRIPTION OF THE INVENTION

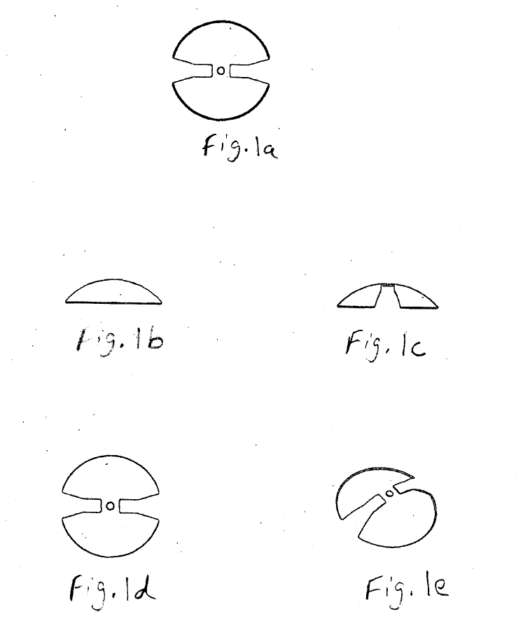

Referring to FIG. 1 which illustrates exhalation valve bottom seat from upper side. A butterfly type exhalation valve comprises a bottom valve body of geometric shape viz. cylindrical or could be oval shape with a boss at one end provided with smooth surface at other end to form a valve seat for mounting a butterfly type diaphragm. The smooth surface (18) minimizes inward leak during Inhalation. The said valve bottom seat is formed on cylindrical or could be oval body at other end having boss at one end on the outer diameter. It's function is not to allow leakage when the diaphragm rests on the seat. The degree of angle for diaphragm seat is so maintained that the diaphragm contours snug fit to the surface. The accurate degree of angle & the edges with radius is important for leak seal performance. Solid base surface in curvature (19 & 22), illustrates leak seal edges from the inner side close to centre pin (20). This also acts as a rib to restrict, hold & rest diaphragm in place during Inhalation. The dimensions of solid base surface in curvature (19 & 22) are maintained to prevent leakage as per design requirement & Intersection of these ribs with edge of smooth surface (18) and form the exhalation slots(16). The four conical slots allow passage of exhaled air through the open space during exhalation process.

The solid pin (20) at the center of the exhalation valve bottom seat that will be used for diaphragm positioning and holding at the centre as fulcrum, so that the butterfly wings diaphragm shall open out during exhalation process from the side edges.

Locating tab & guide (21) are provided for elastomeric diaphragm during inhale-exhale cycle for retaining correct orientation. Locking groove (23) is replaced by alternative method such as ultrasonic welding for engagement of valve top provided for the exhalation valve bottom for engagement with valve top or cap.

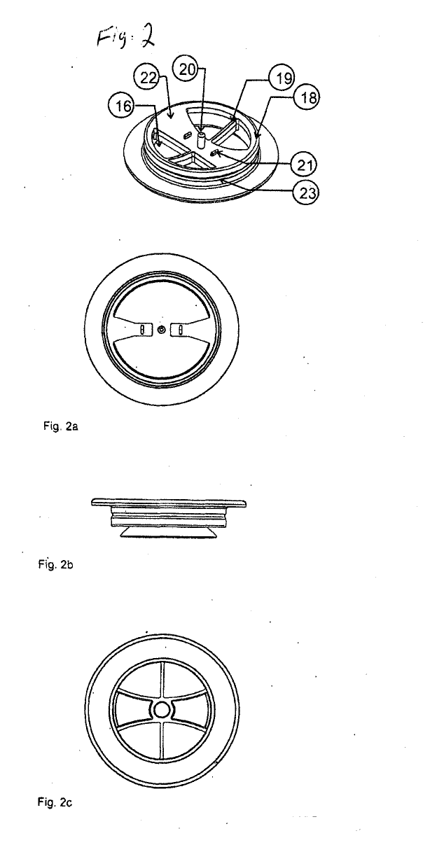

FIGS. 2a, 2b & 2c illustrates front, side & back view of exhalation valve bottom respectively.

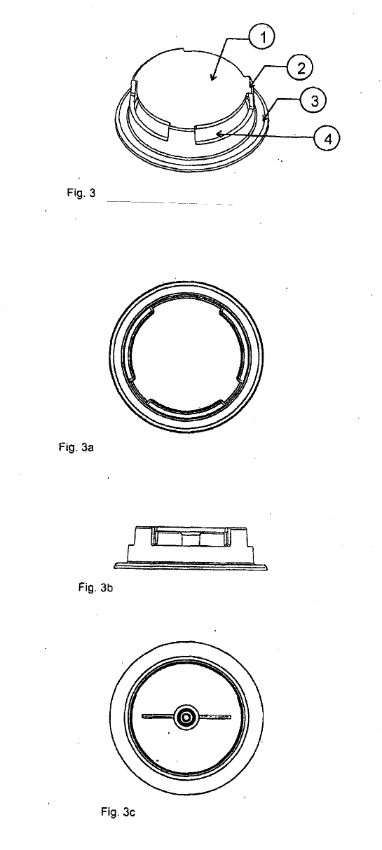

Referring to FIG. 3 which shows the isometric view of the upper lid from top side wherein top portion (1) of the upper lid is for space for visual design & printing, profile (2) for part locating, ribbed base portion (3) of the upper lid helps for engagement/surface grip with fabric during press fit and exhalation slots (4) allows the exhaled air to pass out from the diaphragm when it is released by the exhale. The upper lid is made of polymer. The ribbed base is pressed & engaged in bottom seat with intermediate composite fabric layers of the mask during assembling. The inner & outer diameter of the ribbed base portion (3) helps to provide maximum width margin. Alternatively the top valve cover may be designed as per any geometric shape matching with bottom valve body.

FIG. 3a illustrates the front view of the upper lid, 3b illustrates the side view & FIG. 3c illustrates back view.

There will be at least two guide pins as shown in FIG. 3 on at least two sides placed laterally on the upper lid and at least two guide pins on the bottom seat to support the at least two guide pins on upper lid. This kind of arrangement will allow retaining the valve to the bottom seat once it has moved forward due to exhalation by the user.

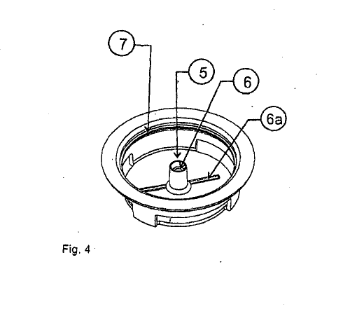

Referring to FIG. 4 which illustrates another isometric view of the upper lid from bottom side, wherein the hollow centre pin (5) having a small concave step (6) inside to maintain appropriate locking, position & holding diaphragm after assembly. The distance of upper lid pin when locked with valve bottom should be just enough for the diaphragm thickness to not create pressure point or gap point which may result in inward leakage. The hollow pin (5) when rests on the diaphragm should lightly touch the diaphragm. If the centre pin (5) creates excess pressure on diaphragm it shall result in leakage of contaminated air inside the mask. The diaphragm should not be over gapped from the pin in the center of the upper lid when it rests on the seat. The locking grove (7) engaged with the locking grove (23) of Exhalation valve bottom after assembly. The vertical protruded ribbed (6a) is restrictor for preventing diaphragm to get locked in open position.

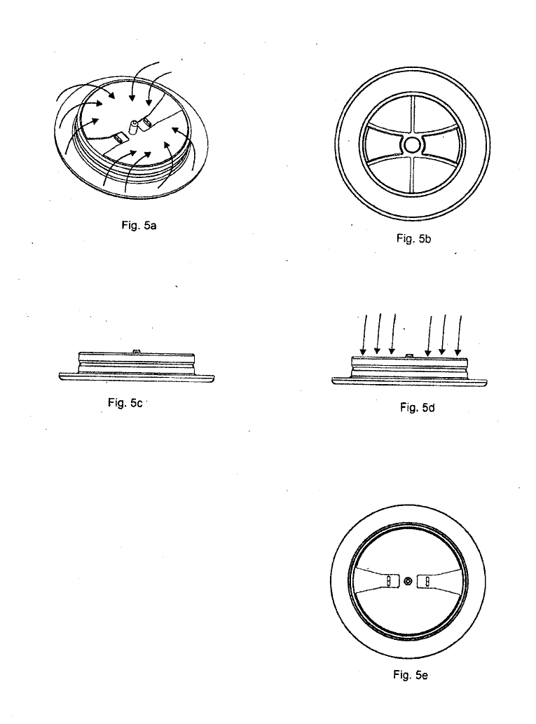

Referring to FIG. 5 which illustrates the working of diaphragm during inhalation process. The arrow mark from the top side of diaphragm indicates the atmospheric pressure & the downward arrow indicates the suction pressure generates during inhalation.

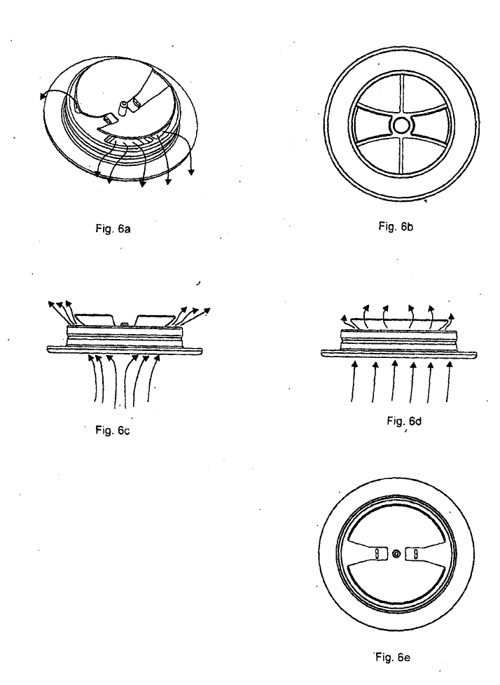

Referring to FIG. 6 which illustrates the working of diaphragm during exhalation process. The arrow mark & position of diaphragm indicates the lift of diaphragm during exhalation cycle at very low flow of air.

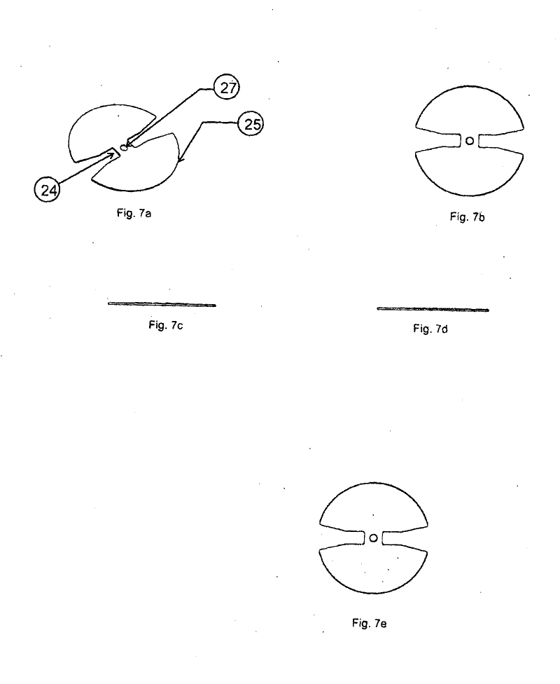

Referring to FIG. 7 which illustrates the elastomeric diaphragm as the critical part of exhalation valve along with the polymer top and seat assembly. This part is designed on butterfly wings concept & the cut portion of the diaphragm is designed for balanced easy movement with minimize efforts. The diaphragm weight is adjusted, that it can operate with even small amount of air exhaled while wearer is talking and/or verbally communicating. Centre hole (27) is provided for preventing any excess pressure & distortion on the diaphragm. Openable flap (25) which is similar to butterfly wings & Square area (24) near centre hole appropriately maintained for better flexibility & preventing side way movement on the seat or Inward leakage.

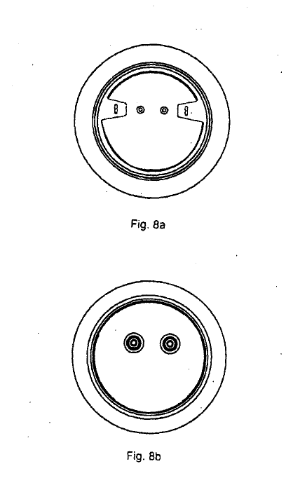

Referring to FIGS. 8a & 8b—In another embodiment there could be one or more fulcrums provided by one or more solid pins at any position more preferably centre or top so that it shall open efficiently during exhalation process. This will allow more holding area for diaphragm improving exhalation and preventing leakage.

As an additional embodiment, fulcrum could be off centre with any number of dissimilar wings. Off centre solid pins at any position of bottom seat can be placed for diaphragm positioning and holding at the off centre as fulcrum. (FIG. 8)

Upper lid of exhalation valve could be modified for giving variety of shapes and appearances for efficient outlet, aesthetics or/and protection of diaphragm.

### Performance Tests of the Present Invention

The primary methods in which it performs better as per universally accepted tests methods for testing of exhalation valve performance in trade are
a) Valve leakage tester as described in various product standards
b) Exhalation flow pressure resistance meter test as described in various product standards.
c) Inward leak fit test of Final product as described in various product standards.

The valve leakage tester tests the leakage of water in 1 min inside 30 ml volume bottle in an apparatus called valve leakage tester. As per the test the air leakage through exhalation valve should not displace more than 30 ml of volume of air per minute at suction @25 mm of water column. If the leakage is more than the specified value then the exhalation valve is considered as failed & may allow contaminated air inside the Filtering face-piece and/or respirator. The performance of the valve is ensured if the leakage is below the specified limits as per standard.

The exhalation flow pressure resistance meter measures the exhalation flow resistance of the overall respirator. Lower the exhalation flow resistance betters the valve performance in terms of comfort & efficient release of exhaled air during the normal respiration process of wearer. Higher efficient exhalation flow resistance may lead to user discomfort & feeling of suffocation. The exhalation flow resistance values limit for filtering face-pieces with respect to filtration class of P1, P2 & P3 should be less than 300 Pascal @ flow rate of 160 L/min.

The inward leak fit test of final product also determines the inward leakage during practical use of the product inside a test chamber wherein leak of contaminated air is monitored.

According to the present invention the butterfly wing shape exhalation valve shows a better performance than the rest of the exhalation valves in these tests in a novel manner.

The butterfly shape cut diaphragm increases the flexibility of the valve and helps to reduce resistance of the valve during the exhalation process. In competitor's valve acting as fixed fulcrum, the bottom of the valve opens as it is U shaped valve and the two holding pin is on top of the U shaped valve. The present invention states that the exhalation valve has a butterfly wings shape cut. Due to the butterfly wings shape cut the valve opens on 2 sides causing the less resistance and preventing increased heart rate or body temperature during respiration process and use of respirator, face-piece or hood exhalation.

The butterfly valve has one hole in its centre. The one hole allows holding the butterfly valve diaphragm from the centre on the bottom portion of the valve seat. This prevents resistance and tightness on the butterfly valve during the exhalation process. These types of valve are also known as Non return valve. The cut feature on both the sides allows easy and efficient flow of air from inside to outside of the valve. It prevents suffocation inside the valve to the wearer during exhalation process and increase comfort to the wearer of the respirator. The butterfly valve is made of elastomeric material. It is designed to arrest in position by tab holders on the two side supports provided on the butterfly valve seat. The centre pin on seat holds the diaphragm on to the valve bottom seat. The top valve lid is also provided to cover the valve bottom lid.

There is minimum leak air inside the butterfly valve as proved through the valve leakage test. The valve shows greater efficiency in that they show valve leakage lesser than 30 ml per minute as per the tests performed which proves effectiveness in disallowing contaminated air to enter inside the respirator/masks/face-piece and/or hood. This prevents contaminated air being inhaled during respiration process.

The valve allows efficient release of the air during exhalation process due to the flaps which are freely moving from both the sides of the butterfly valve diaphragm in a manner causing minimum resistance and causing as much as air to flow out in a free manner without causing discomfort inside the respirator when the wearer exhales out. The pin holds the valve in the centre of the valve holes causing free movement of the valve on both the sides asymmetric manner as per the tidal volume of breathe. The cut on two sides of the diaphragm with corresponding lock pin facilitation also decreases the resistance inside the valve and provides reduced air contamination inside the respirator system providing optimum area to exhale with minimum resistance. This prevents accumulation of exhaled air inside the respirator/masks/face piece or hood and reduced dizziness to the wearer.

1. A butterfly type exhalation valve comprising:
a bottom valve body of geometric shape with a boss at one end and a smooth surface at another end to form a valve seat for mounting a butterfly type diaphragm; a support provided at a center of internal diameter with two or more sector openings forming exhalation slots; one or more solid pins are provided for forming a fulcrum for said diaphragm provided in the center at a distance on said support; one or more locking grooves to the vertical surface of said bottom valve body; a cap having a rigid top provided with one or more hollow pin(s), the center at a distance in the inner side to engage to said solid pin/pins of said valve body with locking when mounted over the bottom valve body after locating said diaphragm to the said solid pin/pins and; a slot on the side surface positioned just below said top of said cap to provide for passage to exhalation air.

2. The butterfly type exhalation valve as claimed in claim 1, further comprising one or more internal locking grooves provided to the inner surface of said cap to engage with the locking grooves of said bottom body; and a circular rib provided at the bottom of the cap, the rib matching with said boss at the bottom of the valve body.

3. The butterfly type exhalation valve as claimed in claim 1, wherein the hollow pin has a small concave inside step to maintain appropriate locking, position and holding of the diaphragm after assembly so that the distance of the upper lid pin when locked with the valve bottom is just enough to accommodate for the diaphragm thickness so as not to create a pressure point or a gap point which may result in inward leakage.

4. The butterfly type exhalation valve as claimed in claim 1, wherein said support comprises two numbers of curved cross ribs forming four numbers of exhalation slots, with the solid pin in the center forming the fulcrum.

5. The butterfly type exhalation valve as claimed in claim 4, wherein one of said curved cross ribs has a wider width which is wider than the width of the other cross ribs.

6. The butterfly type exhalation valve as claimed in claim 4, wherein a pair of locating tabs and guides are provided on said wider width rib and centrally aligned at equidistant from said solid pin.

7. The butterfly type exhalation valve as claimed in claim 1, wherein said valve seat has a smooth surface for leak tight resting of said diaphragm on the seat, and having a degree of angle for the diaphragm seat so that diaphragm contours to a snug fit to the surface.

8. The butterfly type exhalation valve as claimed in claim 1, wherein the diaphragm is made from elastomeric sheet material of circular/oval shape formed into a butterfly shape by cutting.

9. The butterfly type exhalation valve as claimed in claim 1, wherein the diaphragm is made from elastomeric sheet material of circular shape formed into a butterfly shape by cutting.

10. The butterfly type exhalation valve as claimed in claim 1, wherein said cap inner base is provided with at least protruded ribbed two sides placed laterally to support said guide pins on the bottom seat.
